(19) United States
(12) Patent Application Publication
(10) Pub. No.: US 2017/0235715 A1
(43) Pub. Date: Aug. 17, 2017

(54) DOCUMENT TERMINOLOGY PARSER SYSTEM AND METHOD

(71) Applicant: NetSuite Inc., San Mateo, CA (US)

(72) Inventor: Peter Alan Redrup, Kurim (CZ)

(21) Appl. No.: 14/597,512

(22) Filed: Jan. 15, 2015

Related U.S. Application Data
(60) Provisional application No. 61/977,722, filed on Apr. 10, 2014.

(51) Int. Cl. G06F 17/27; G06F 17/30

(52) U.S. Cl. CPC G06F 17/2705; G06F 17/30011

(57) ABSTRACT

A system and method are shown for automatically generating documents with customer preferred terminology that involves providing basic terminology documents for a system, storing customer specific terminology for customers, receiving requests for a basic terminology document, searching the basic terminology document for a tag placeholder corresponding to a redefined term in the customer specific terminology for a customer, replacing the tag placeholder with the redefined term in order to create a customer specific terminology document for the customer, and providing the customer specific terminology document for display. In one embodiment, a multi-tenant system may provide different customers of the system with their own specific terminology for basic documents.

### CROSS REFERENCE TO RELATED APPLICATIONS

This application claims the benefit of priority to U.S. Provisional Patent Appl. No. 61/977,722 filed Apr. 10, 2014 and entitled “Document Terminology Parser,” which is incorporated by reference herein in its entirety for all purposes.

### BACKGROUND

Many data processing or computing systems and platforms are intended to be used by a variety of users, such as employees, clients, vendors, and customers. These users typically use terms of art and/or trade names as well as specific terminology that they use internally as part of operating their businesses. Some of the terminology used internally may differ from that used by others for the same or a similar concept or product. In order to meet the needs of users who typically use different terminology, a system may allow customers to rename elements of the base terminology used within the system. For example, the base term ‘Project’ may be renamed by a business to ‘Job’ or ‘Engagement’ to better reflect the business' own internal usage and make use of the system more efficient and intuitive for users who are accustomed to that term. The renamed term or concept may then be displayed throughout the screens they see as they use the system or platform, but not in the associated documentation (such as help screens, user manuals, etc.).

In order to effectively use typical documentation, users are expected to know the base system terminology, even though they may not see it on their display screens and are not accustomed to using it internally in their business. This makes it considerably more difficult for employees and customers to use the documentation in order to search for help or answers to their questions. In practice, customers may have to resort to writing their own documentation or may simply avoid using the system documentation entirely. This can result in lower customer satisfaction, increase the cost of deploying services, and increase the pressure on support staff.

Embodiments of the invention allow customers to read documentation and search for help using the terminology they use internally in their business and see on their display screens when they use a data processing or computing system. This solution will reduce the need for customers to write their own documentation and reduce their reliance on support services. Conventional approaches to providing support documentation for products or services fail to address the problems caused by users being more familiar with and preferring to use different terminology for certain concepts. Embodiments of the invention are directed toward solving these and other problems individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the invention are directed to systems, apparatuses, and methods for enabling users to generate help files and support documents that use a user's preferred terminology. Embodiments of the invention are also directed to systems, apparatuses, and methods for enabling users to perform searches of such documentation using their preferred terminology. Both the documentation generation and search embodiments may make use of “placeholders” in the definition of a document or search term, where such placeholders may include markup language tags, etc.

In an embodiment of a system for automatically generating documents with customer preferred terminology, the system has at least one server configured to provide at least one basic terminology document for a system, store customer specific terminology for a first customer, and receive a request for the basic terminology document for the first customer. The server searches the basic terminology document for at least one tag placeholder corresponding to a redefined term in the customer specific terminology for the first customer, preprocesses the basic terminology document to replace the tag placeholder with the redefined term in order to create a customer specific terminology document for the first customer, and provides the customer specific terminology document for the first customer for display. In one refinement, the system is a multi-tenant system with multiple tenants, where different tenant customers are able to define their own customer specific terminology for use in basic terminology documents provided by the system.

In another embodiment of a system for automatically generating documents with customer preferred terminology a server receives a search request for basic terminology documents for the first customer, searches the search request for redefined terms in the customer specific terminology for the first customer, replaces each redefined term in the search request with a corresponding tag placeholder corresponding to the redefined term in the search request, and searches the basic terminology documents using the corresponding tag placeholders for the redefined terms in the search request. In yet another embodiment, the server detects at least one capitalized character in the tag placeholder and capitalizes a character in the redefined term that corresponds to the capitalized character in the tag placeholder. In still another embodiment, the server detects a plural character in the tag placeholder and provides a plural form of the redefined term. In still another embodiment, the server detects an indefinite article preceding the tag placeholder and replaces the indefinite article preceding the tag placeholder with an indefinite article that is appropriate for the redefined term.

An embodiment of a method for automatically generating documents with customer preferred terminology involves providing at least one basic terminology document for a system, storing customer specific terminology for a first customer, and receiving a request for the basic terminology document for the first customer. The method also involves searching the basic terminology document for at least one tag placeholder corresponding to a redefined term in the customer specific terminology for the first customer, preprocessing the basic terminology document to replace the tag placeholder with the redefined term in order to create a customer specific terminology document for the first customer, and providing the customer specific terminology document for the first customer for display.

An embodiment of a computer readable medium has computer-executable instructions stored thereon which, when executed by a computer, will cause the computer to perform a process for automatically generating documents with customer preferred terminology, where the process entails providing at least one basic terminology document for a system, storing customer specific terminology for a first customer, and receiving a request for the basic terminology document for the first customer. The process also entails searching the basic terminology document for at least one tag placeholder corresponding to a redefined term in the customer specific terminology for the first customer, preprocessing the basic terminology document to replace the tag placeholder with the redefined term in order to create a customer specific terminology document for the first customer, and providing the customer specific terminology document for the first customer for display.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1 is a diagram illustrating elements or components of an example operating environment in which an embodiment of the invention may be implemented;

FIG. 2 is a diagram illustrating additional details of the elements or components of the multi-tenant distributed computing service platform of FIG. 1, in which an embodiment of the invention may be implemented;

FIG. 3 is a flow chart or flow diagram illustrating a process, method, operation, or function for generating and searching user specific documentation that may be used when implementing an embodiment of the invention;

FIG. 4 is a schematic diagram illustrating an example of a user interface 450 that may be employed in steps or stages 402 and 404 of FIG. 3;

FIG. 5 is an example of an XML source document 460 corresponding to the example of FIG. 4;

FIG. 6 is a diagram illustrating the search results that might be returned to a user from a search request for “Job”, and include the original HTML document 470;

FIG. 7 is a control flow diagram illustrating one example of a document display preprocessor configured to swap out terminology placeholders in source HTML document 470 with customer specific terminology in a data store 482 before the preprocessed HTML document 490 is displayed to a user;

FIG. 8 is a diagram illustrating the resulting preprocessed HTML document 490 containing a customer's preferred terminology as displayed to the user;

FIG. 9 is a control flow diagram illustrating a method of searching in terminology enabled documents, as might be implemented by an embodiment of the invention; and

FIG. 10 is a diagram illustrating elements or components that may be present in a computer device or system configured to implement a method, process, function, or operation in accordance with an embodiment of the invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that are part of a client device, server, network element, or other form of computing or data processing device/platform and that are programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

Embodiments of the present invention are directed to systems, apparatuses, and methods for permitting a user to generate and search documentation (such as help files, user manuals, etc.) for a product or service using a set of preferred terminology. This permits a user to maintain usage of their internal terminology while still having access to files and documentation generated by the provider of a product or service. In some embodiments, this capability is enabled by use of markup language based templates or files in which “placeholders” are substituted for terms or concepts that a user wishes to replace with their own preferred terminology. In some embodiments a user's search may be entered using one or more of the user's preferred terms, with those terms then replaced by the terms used in the documentation generated by the provider of the product or service to form a search query. The results of executing the query can then be processed to replace the placeholders with the user's preferred terminology.

Embodiments of the invention may be used in conjunction with any set of files, documents, displays, webpages, etc. that contain information about a product or service. This may include user manuals, help files, FAQs, screen shots, or other material intended to assist a user in installing, using, answering questions about, or troubleshooting a product or service. As an example, an embodiment of the invention may be used as part of an on-line product or service support system, as part of a set of electronic manuals or documents provider to a user for use on their own system or network, or as part of a server platform providing web services and/or data processing services to one or more users (such as a multi-tenant data processing platform/system).

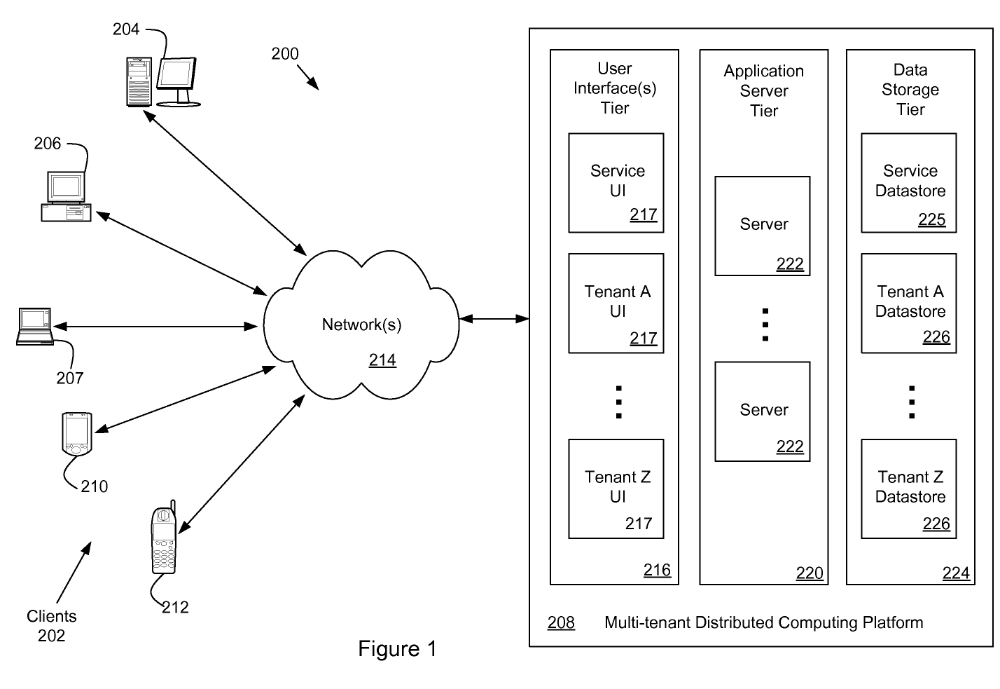

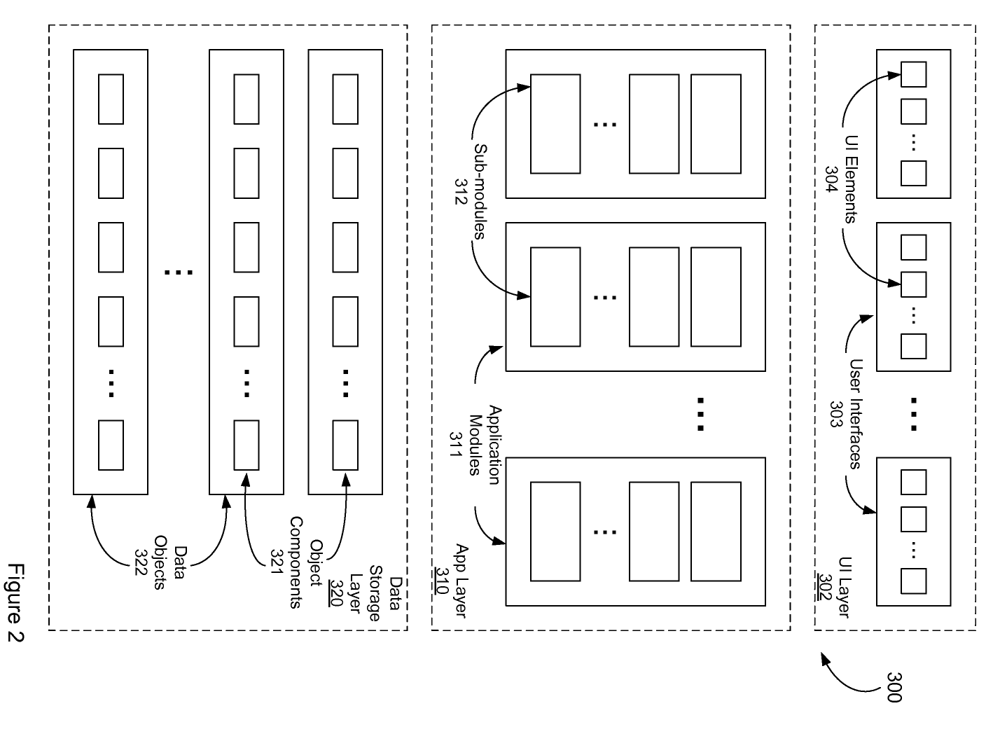

As noted, in some embodiments, the invention may be implemented in the context of a multi-tenant, “cloud” based environment (such as a multi-tenant business data processing platform), typically used to develop and provide web services for end users. This exemplary implementation environment will be described with reference to FIGS. 1 and 2. Note that as mentioned, embodiments of the invention may also be implemented in the context of other computing or operational environments or systems, such as for an individual business data processing system, a private network used with a plurality of client terminals, a remote or on-site data processing system, another form of client-server architecture, etc.

Modern computer networks incorporate layers of virtualization so that physically remote computers and computer components can be allocated to a particular task and then reallocated when the task is done. Users sometimes speak in terms of computing “clouds” because of the way groups of computers and computing components can form and split responsive to user demand, and because users often never see the computing hardware that ultimately provides the computing services. More recently, different types of computing clouds and cloud services have begun emerging.

For the purposes of this description, cloud services may be divided broadly into “low level” services and “high level” services. Low level cloud services (sometimes called “raw” or “commodity” services) typically provide little more than virtual versions of a newly purchased physical computer system: virtual disk storage space, virtual processing power, an operating system, and perhaps a database such as an RDBMS. In contrast, high or higher level cloud services typically focus on one or more well-defined end user applications, such as business oriented applications. Some high level cloud services provide an ability to customize and/or extend the functionality of one or more of the end user applications they provide; however, high level cloud services typically do not provide direct access to low level computing functions.

The ability of business users to access crucial business information has been greatly enhanced by the proliferation of IP-based networking together with advances in object oriented Web-based programming and browser technology. Using these advances, systems have been developed that permit web-based access to business information systems, thereby allowing a user with a browser and an Internet or intranet connection to view, enter, or modify business information. For example, substantial efforts have been directed to Enterprise Resource Planning (ERP) systems that integrate the capabilities of several historically separate business computing systems into a common system, with a view toward streamlining business processes and increasing efficiencies on a business-wide level. By way of example, the capabilities or modules of an ERP system may include (but are not required to include, nor limited to only including): accounting, order processing, time and billing, inventory management, employee management/payroll, human resources management, and employee calendaring and collaboration, as well as reporting and analysis capabilities relating to these functions.

In a related development, substantial efforts have also been directed to integrated Customer Relationship Management (CRM) systems, with a view toward obtaining a better understanding of customers, enhancing service to existing customers, and acquiring new and profitable customers. By way of example, the capabilities or modules of a CRM system can include (but are not required to include, nor limited to only including): sales force automation (SFA), marketing automation, contact list, call center support, and web-based customer support, as well as reporting and analysis capabilities relating to these functions. With differing levels of overlap with ERP/CRM initiatives and with each other, efforts have also been directed toward development of increasingly integrated partner and vendor management systems, web store/eCommerce systems, product lifecycle management (PLM) systems, and supply chain management (SCM) systems.

FIG. 1 is a diagram illustrating elements or components of an example operating environment 200 in which an embodiment of the invention may be implemented. As shown, a variety of clients 202 incorporating and/or incorporated into a variety of computing devices may communicate with a distributed computing service/platform 208 through one or more networks 214. For example, a client may incorporate and/or be incorporated into a client application (e.g., software) implemented at least in part by one or more of the computing devices. Examples of suitable computing devices include personal computers, server computers 204, desktop computers 206, laptop computers 207, notebook computers, tablet computers or personal digital assistants (PDAs) 210, smart phones 212, cell phones, and consumer electronic devices incorporating one or more computing device components, such as one or more electronic processors, microprocessors, central processing units (CPU), or controllers. Examples of suitable networks 214 include networks utilizing wired and/or wireless communication technologies and networks operating in accordance with any suitable networking and/or communication protocol (e.g., the Internet).

The distributed computing service/platform (which may also be referred to as a multi-tenant business data processing platform) 208 may include multiple processing tiers, including a user interface tier 216, an application server tier 220, and a data storage tier 224. The user interface tier 216 may maintain multiple user interfaces 217, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs). The default user interface may include components enabling a tenant to administer the tenant's participation in the functions and capabilities provided by the service platform, such as accessing data, causing the execution of specific data processing operations, etc. Each processing tier shown in the figure may be implemented with a set of computers and/or computer components including computer servers and processors, and may perform various functions, methods, processes, or operations as determined by the execution of a software application or set of instructions. The data storage tier 224 may include one or more data stores, which may include a Service Data store 225 and one or more Tenant Data stores 226.

Each tenant data store 226 may contain tenant-specific data that is used as part of providing a range of tenant-specific business services or functions, including but not limited to ERP, CRM, eCommerce, Human Resources management, payroll, etc. Data stores may be implemented with any suitable data storage technology, including structured query language (SQL) based relational database management systems (RDBMS).

In accordance with one embodiment of the invention, distributed computing service/platform 208 (e.g., a multi-tenant business data processing platform) may be operated by an entity in order to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an Enterprise Resource Planning (ERP) system that integrates the capabilities of several historically separate business computing systems into a common system, with the intention of streamlining business processes and increasing efficiencies on a business-wide level. By way of example, the capabilities or modules of an ERP system may include: accounting, order processing, time and billing, inventory management, employee management/payroll, and employee calendaring and collaboration, as well as reporting and analysis capabilities relating to these functions. Another business information system that may be provided as part of an integrated service platform is an integrated Customer Relationship Management (CRM) system, which is designed to assist in obtaining a better understanding of customers, enhance service to existing customers, and assist in acquiring new and profitable customers. By way of example, the capabilities or modules of a CRM system may include: sales force automation (SFA), marketing automation, contact list management, call center support, and web-based customer support, as well as reporting and analysis capabilities relating to these functions. In addition to ERP and CRM functions, a business information system/platform (such as element 208 of FIG. 2) may also include one or more of an integrated partner and vendor management system, eCommerce system (e.g., a virtual storefront application or platform), product lifecycle management (PLM) system, Human Resources management system (which may include medical/dental insurance administration, payroll, etc.), or supply chain management (SCM) system.

Note that both functional advantages and strategic advantages may be gained through the use of an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functionalities may advantageously be integrated and executed by a single code base accessing one or more integrated databases as necessary, forming an integrated business management system or platform.

The integrated business system shown in FIG. 1 may be hosted on a distributed computing system made up of at least one, but typically multiple, “servers.” A server is a physical computer dedicated to run one or more software services intended to serve the needs of the users of other computers in data communication with the server, for instance via a public network such as the Internet or a private “intranet” network. The server, and the services it provides, may be referred to as the “host” and the remote computers and the software applications running on the remote computers may be referred to as the “clients.” Depending on the computing service that a server offers it could be referred to as a database server, file server, mail server, print server, web server, etc. A web server is a most often a combination of hardware and the software that helps deliver content (typically by hosting a website) to client web browsers that access the web server via the Internet.

Rather than build and maintain such an integrated business system themselves, a business may utilize systems provided by a third party. Such a third party may implement an integrated business system/platform as described above in the context of a multi-tenant platform, wherein individual instantiations of a single comprehensive integrated business system are provided to a variety of tenants. One advantage to such multi-tenant platforms is the ability for each tenant to customize their instantiation of the integrated business system to that tenant's specific business needs. Each tenant may be a business or entity that uses the multi-tenant platform to provide business data and functionality to multiple users. Some of those multiple users may have distinct roles or responsibilities within the business or entity. Some users within an organization may have a preference for using certain internally adopted terminology instead of terminology used by the administrators of a system or platform, or the authors of help files or other documentation. Embodiments of the invention provide a system and methods for enabling a user to specify preferred terminology and for that terminology to be used in files, help material, and other documentation and in searches executed by the user over that set of files and documentation.

In some cases, a tenant may desire to modify or supplement the functionality of an existing platform application by introducing an extension to that application, where the extension is to be made available to the tenant's employees and/or and customers. In some cases such an extension may be applied to the processing of the tenant's business related data that is resident on the platform. The extension may be developed by the tenant or by a 3^{rd} party developer and then made available to the tenant for installation. The platform may include a “library” or catalog of available extensions, which can be accessed by a tenant and searched to identify an extension of interest. Software developers may be permitted to “publish” an extension to the library or catalog after appropriate validation of a proposed extension.

Thus, in an effort to permit tenants to obtain the services and functionality that they desire (which may include providing certain services to their end customers, such as an eCommerce platform), a multi-tenant service platform may permit a tenant to configure certain aspects of the available service(s) to better suit their business needs. In this way aspects of the service platform may be customizable, and thereby enable a tenant to configure aspects of the platform to provide distinctive services to their respective users or to groups of those users. For example, a business enterprise that uses the service platform may want to provide additional functions or capabilities to their employees and/or customers (such as the capabilities described herein), or to cause their business data to be processed in a specific way in accordance with a defined workflow that is tailored to their business needs, etc.

Tenant customizations to the platform may include custom functionality (such as the capability to perform tenant or user-specific functions, data processing, or operations) built on top of lower level operating system functions. Some multi-tenant service platforms may offer the ability to customize functions or operations at a number of different levels of the service platform, from aesthetic modifications to a graphical user interface to providing integration of components and/or entire applications developed by independent third party vendors. This can be very beneficial, since by permitting use of components and/or applications developed by third party vendors, a multi-tenant service can significantly enhance the functionality available to tenants and increase tenant satisfaction with the platform.

As noted, in addition to user customizations, an independent software developer may create an extension to a particular application that is available to users through a multi-tenant data processing platform. The extension may add new functionality or capabilities to the underlying application. One or more tenants/users of the platform may wish to add the extension to the underlying application in order to be able to utilize the enhancements to the application that are made possible by the extension.

FIG. 2 is a diagram illustrating additional details of the elements or components of the multi-tenant distributed computing service platform of FIG. 1, in which an embodiment of the invention may be implemented. The software architecture depicted in FIG. 2 represents an example of a complex software system to which an embodiment of the invention may be applied. In general, an embodiment of the invention may be used in conjunction with any set of software instructions that are designed to be executed by a suitably programmed processing element (such as a CPU, microprocessor, processor, controller, computing device, etc.). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 2 is a diagram illustrating additional details of the elements or components 300 of the multi-tenant distributed computing service platform of FIG. 1, in which an embodiment of the invention may be implemented. The example architecture includes a user interface layer or tier 302 having one or more user interfaces 303. Examples of such user interfaces include graphical user interfaces and application programming interfaces (APIs). Each user interface may include one or more interface elements 304. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols.

The application layer 310 may include one or more application modules 311, each having one or more sub-modules 312. Each application module 311 or sub-module 312 may correspond to a particular function, method, process, or operation that is implemented by the module or sub-module. Such function, method, process, or operation may include those used to implement one or more aspects of the inventive system and methods, such as for:
Presenting a user interface to an authorized user for entry of preferred terminology and associating that preferred terminology with standardized terminology used by the provider of a product or service;
Replacing one or more instances of the standardized terminology with a suitable “placeholder”;
Storing a record of the user's preferred terminology and its associated standardized terminology;
Presenting search results to the user by substituting the user's preferred terminology in the appropriate placeholder for the associated standardized terminology; and
Substituting the associated standardized terminology in the appropriate placeholder for each instance of the user's preferred terminology that is used by the user when constructing a search query.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 222 of FIG. 1) may include each application module. Alternatively, different application servers may include different sets of application modules. Such sets may be disjoint or overlapping.

The data storage layer 320 may include one or more data objects 322 each having one or more data object components 321, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 1-2 are not intended to be limiting examples. Alternatively, or in addition, computing environments in which an embodiment of the invention may be implemented include any suitable system or application that permits users to search for and access information about a product or service. Example environments in which an embodiment of the invention may be implemented include devices (including mobile devices), software applications, systems, apparatuses, networks, or other configurable components that may be used by multiple users for data entry, data processing, application execution, data review, etc. and which include or provide access to product or service information such as help files, user manuals, installation instructions, etc. Although further examples may reference the example computing environment depicted in FIGS. 1-2, it will be apparent to one of skill in the art that the examples may be adapted for alternate computing devices, systems, apparatuses, processes, and environments.

A multi-tenant system that supports multiple tenants or customers may provide basic documentation, such as user documentation, menus and help screens, to those customers. The basic documentation provided will typically utilize the terminology determined by the provider of the documentation. The multi-tenant customers, however, may prefer to use different terminology in their business operations.

To use typical documentation, users are expected to know the base terminology even though they may not see it in on their screens. This makes it considerably more difficult for users to use the documentation and search for help. In practice, customers may resort to writing their own documentation or simply avoid using the host system documentation. The consequences may include lower customer satisfaction, increased cost for deploying services, and increased pressure on support services.

To meet the needs of tenants or customers with different terminology, an embodiment of the inventive system may be provided to allow customers to rename the base terminology used, for example, in user documentation and help pages. For example, the base term ‘Project’ may be renamed by a customer to ‘Job’ or ‘Engagement’. This new name is then displayed throughout the screens that a user or that customer sees as they use the system, but the base terminology documentation remains unchanged. Embodiments may allow users or a customer to read documentation and search for help using the terminology the customer uses in their business and typically views on their screens when they use the system. This solution may reduce the need for customers to write their own documentation and reduce their reliance on support services.

In the inventive terminology enabled documentation, the basic terminology documents, such as HTML pages, use tag placeholders instead of fixed terminology phrases used by a customer. This allows the same documentation to be used by multiple customers, such as the customers of a multi-tenant system, even though each customer may use their own preferred terminology. The tag placeholders are replaced by the customer's defined terminology phrases when a user of the customer requests to view a document. Customer searches may also be interpreted into placeholder searches to allow users to find relevant basic terminology documents using the customer's specific terminology.

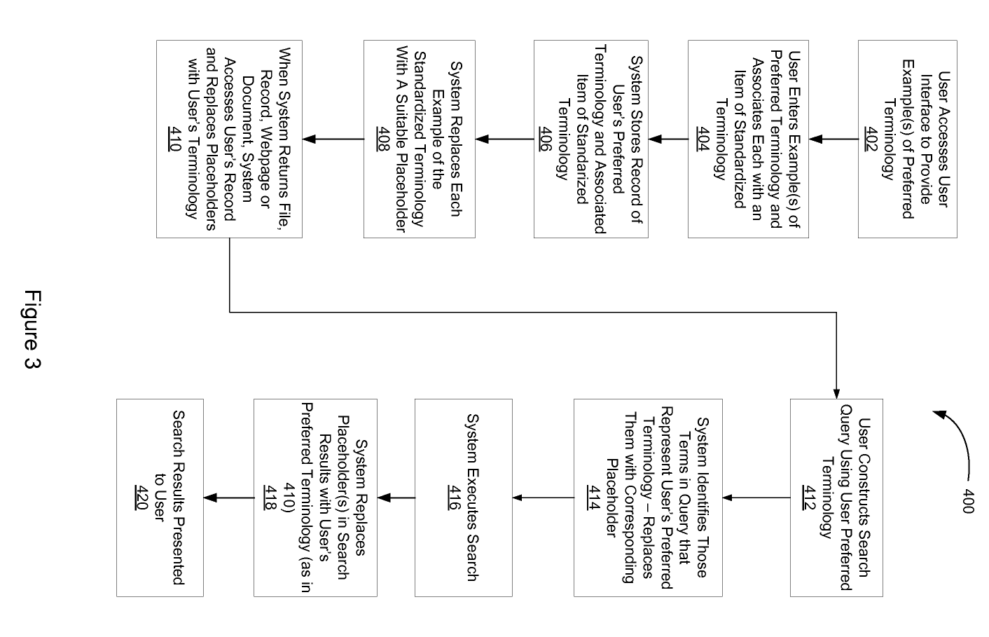

FIG. 3 is a flow chart or flow diagram illustrating a process, method, operation, or function 400 for generating and searching user specific documentation that may be used when implementing an embodiment of the invention. As shown in the figure, in one embodiment, a user of a system, device, network, apparatus, application, or process may access a user interface display to provide examples of the user's preferred terminology (step or stage 402). In one embodiment, the user interface may permit the user to enter one or more examples of the user's preferred terminology and to associate each example with an item of standardized terminology (stage or step 404). The system stores a data record of each example of the user's preferred terminology and its associated item of standardized terminology (stage or step 406). The system also replaces each item of standardized terminology identified by the user with a suitable “placeholder” (such as a “tag” for a webpage containing relevant information), as illustrated at step or stage 408.

When the user accesses (or the system returns) a file or document containing one or more items of standardized terminology that the user desires to replace with their own preferred terminology, the system access the user's stored data record and uses it to replace each placeholder with the user's preferred term or terms (step or stage 410). Similarly, when the user constructs a search query, the system identifies those terms in the query that represent the user's preferred terminology and replaces them with the suitable placeholder (steps or stages 412 and 414). The search is then executed over the relevant files or documents (step or stage 416). The set of search results is then processed by the system as described with reference to step 410 before being presented to the user (steps or stages 418 and 420).

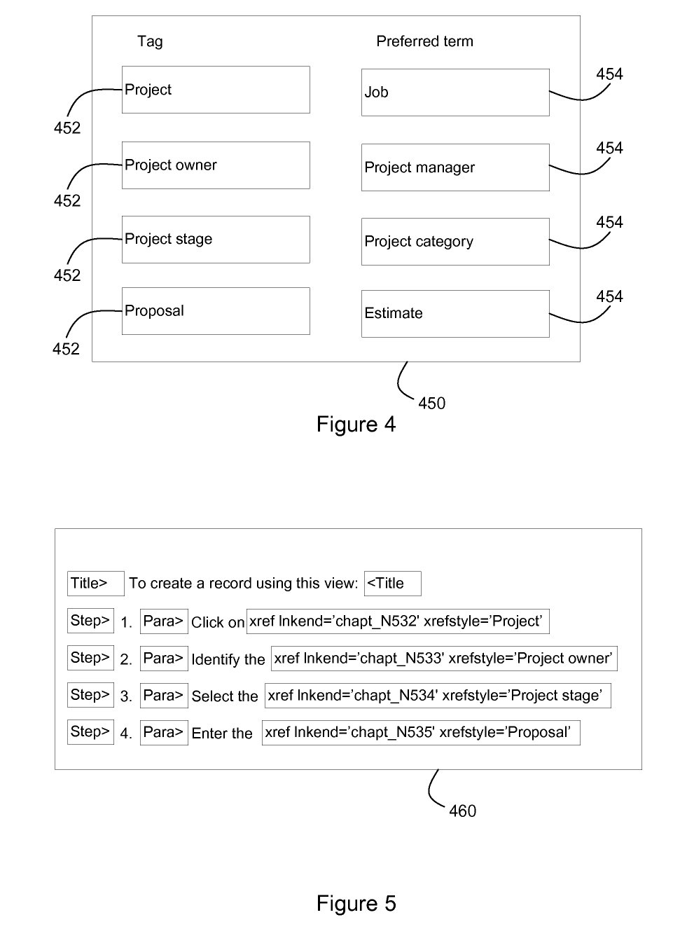

FIG. 4 is a schematic diagram illustrating an example of a user interface 450 that may be employed in steps or stages 402 and 404 of FIG. 3. A column of tag fields 452 is provided, where each tag corresponds to an item of standardized terminology used in a document or collection of documents. A column of preferred term fields 454 that corresponds to the column of tag fields 452 is provided for a user to enter text for preferred terms corresponding to the tags. In the first row, for example, the “Project” tag field 452 has a preferred term “Job” entered in the corresponding preferred term field.

FIG. 5 is an example of an XML source document 460 corresponding to the example of FIG. 4. XML document 460 is created using an editor that is configured to recognize a terminology tag. A user of the editor defines the text for document, e.g. “1. Click on”, and a terminology tag, e.g. “xref Inkend=‘chapt_N532’ xrefstyle=‘Project’”, to identify customer terminology phrases that can be changed by the customer. A customer uses the user interface 450 of FIG. 4 to define their preferred terminology, which is stored in a database.

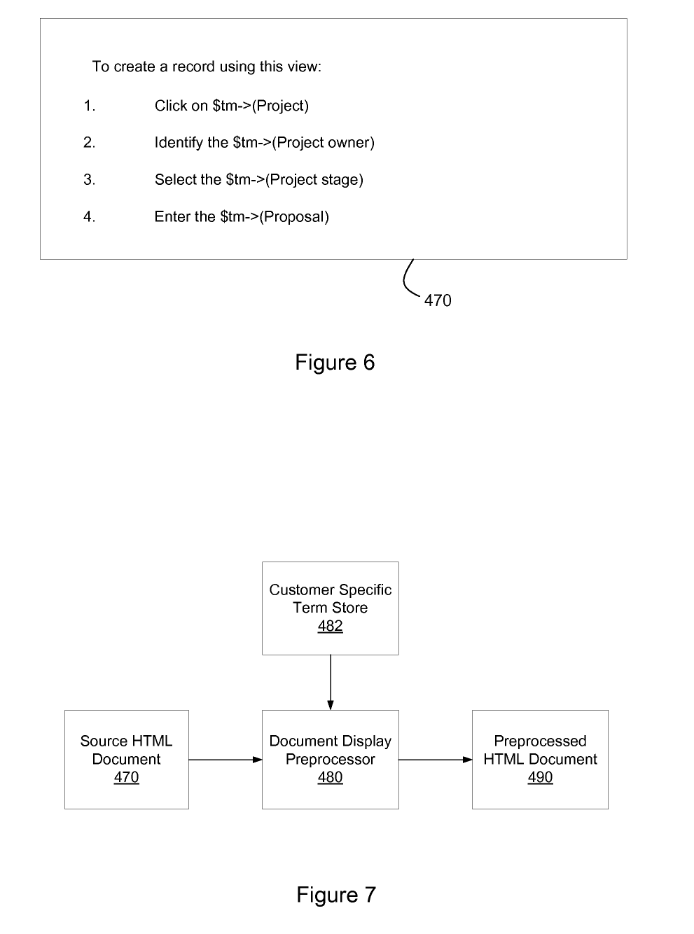

In one example, the XML document 460 is processed by a make utility to create an HTML document 470, such as the example shown in FIG. 6, which contains terminology placeholders that identify the terminology tags that can be replaced with the customer's specific terminology and can be preprocessed to swap out phrases identified by the terminology tags or placeholders with the customer's preferred terminology. For example, Perl function calls, e.g. $tm->(Project), or JavaScript function calls, e.g. readTerm(‘Project’), are placeholders in the HTML document 470 that may be executed to swap in the customer's preferred term. The HTML document may then be stored for future use. The XML document may also be converted to a PDF format document.

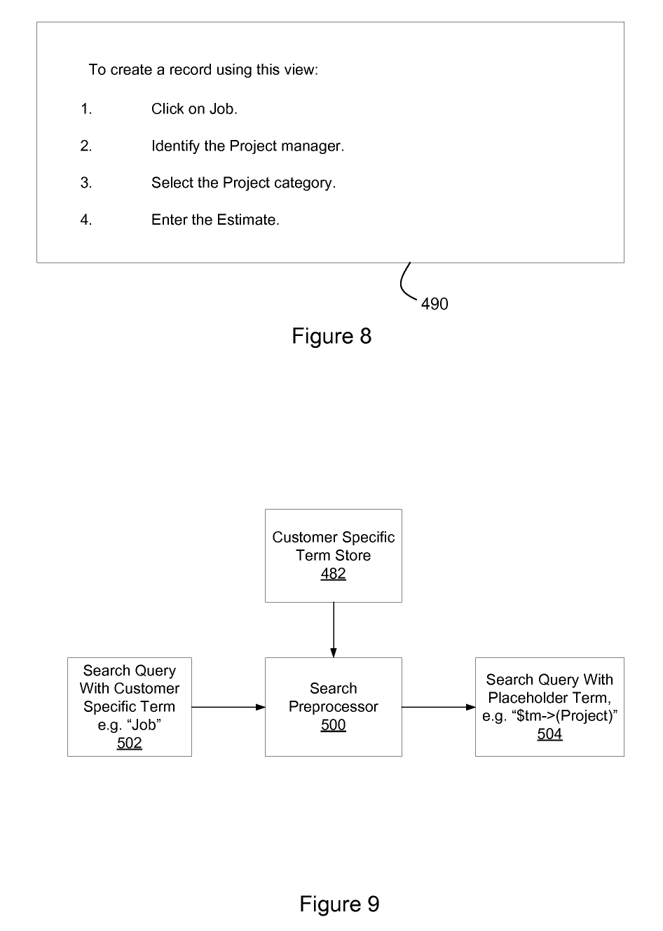

FIG. 7 is a control flow diagram illustrating one example of a document display preprocessor configured to swap out terminology placeholders in source HTML document 470 with customer specific terminology in a data store 482 before the preprocessed HTML document 490 is displayed to a user. The preprocessor 480 converts a placeholder in the HTML document 490, e.g. $tm->(Project), into the customer's preferred term, e.g. “Job”. The resulting preprocessed HTML document 490 will contain the customer's preferred terminology when displayed to a user, as illustrated in the example of FIG. 8.

Aspects of the present invention are also directed to methods of searching in terminology enabled documents, as illustrated in FIG. 9. In one embodiment, a search query 502 is entered by the customer using the customer's specific terminology, e.g. “Job”. A search preprocessor 500 processes a search string of the search query and replaces customer specific terminology with terminology placeholders, e.g. $tm->(Project), based on the associations defined by the user as stored in customer specific terminology store 482 in order to produce a search query 504 containing the substituted placeholder terminology. The preprocessed search query 504 may then be processed by a standard search facility to search for possible matches in the terminology enabled documentation. For example, a user search request for “Job” will return search results that include the original HTML document 470 of FIG. 6.

There are a number of alternative implementations for converting between placeholders and terminology phrases. In one implementation, the user renames a base term such as “project” to their internal term, such as “job”, without needing to address the implications in the document with regard to capital letters, plural forms, indefinite articles, etc. These alternative implementations may include features that allow a document writer to control how the placeholder is converted to the customer specified terminology phrase.

In one example of an implementation feature, the case is taken from the placeholder and not the terminology phrase. Thus, for the placeholder tag $tm->(project), the tag is converted to “project” or “job”. However, for the placeholder tag $tm->(Project), the tag is converted to “Project” or “Engagement” because the tag name is upper case.

In another example of an implementation feature, the system automatically detects plurals in placeholders and applies rules to create the correct plural form. The user does not need to separately define singular and plural forms. A terminology enabled document includes the following: Select one placeholder tag $tm->(client) or two placeholder tag $tm->(clients) to approve. If a customer has not provided a defined a preferred terminology for this tag, it will be converted to “Select one client or two clients to approve.” If the customer has defined a preferred terminology for $tm->(client) to be company, then the text will be converted to “Select one company or two companies to approve.” The customer only has to redefine “client” to “company” in their terminology database. They do not need to define a plural form for the terminology phrase.

In yet another example of an implementation feature, the system automatically accounts for indefinite articles. For example, if a customer redefines the terminology for “project” to “engagement”, then indefinite articles preceding the terminology phrase need to be changed, i.e. ‘a’ to ‘an’. Thus, if the base document reads “Select a project to approve”, then the indefinite article is recognized and the terminology enabled document is automatically revised to read “Select an engagement to approve.” In one approach, the placeholder is prefixed with ‘a_’, which indicates that an indefinite article is required for the particular instance of the terminology. When the document is preprocessed to swap in the customer defined terminology, the system will automatically apply a series of rules to determine if the instance requires ‘a’ or ‘an’ for the indefinite article. For example, an instance in a terminology enabled document of the placeholder tag $tm->(a_project), i.e. “Select $tm->(a_project) to approve”, will be processed to “a project” if no customer preferred term is defined, but is processed to “an engagement” if it has been defined to “engagement”. An author of a terminology enable document may need to understand these sorts of functions when drafting the document in order to utilize these features.

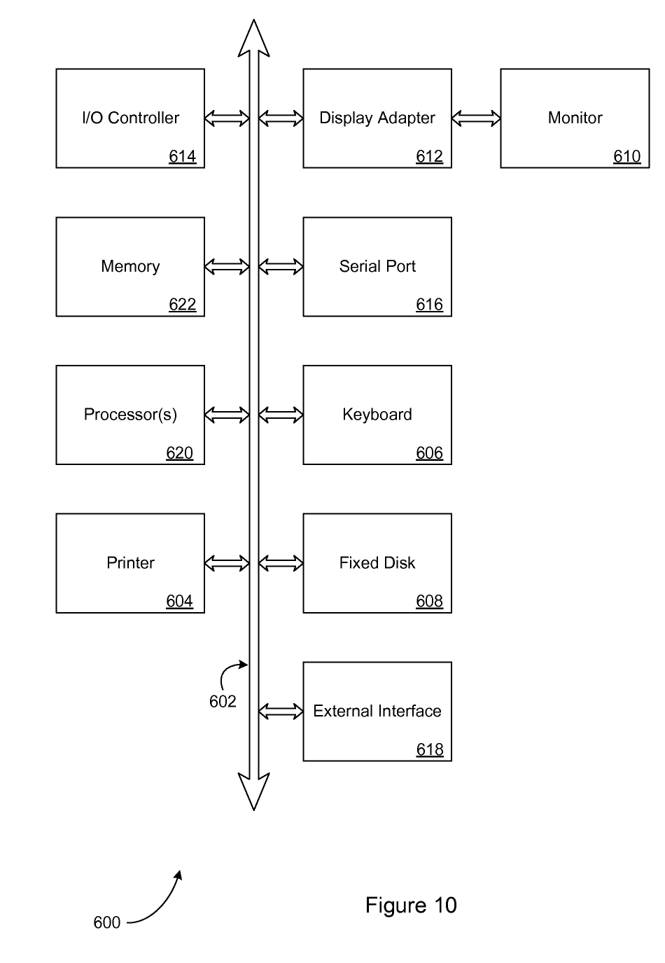

In accordance with one embodiment of the invention, the system, apparatus, methods, processes, functions, and/or operations for enabling efficient configuration and presentation of a user interface to a user based on the user's previous behavior may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 10 is a diagram illustrating elements or components that may be present in a computer device or system 600 configured to implement a method, process, function, or operation in accordance with an embodiment of the invention. The subsystems shown in FIG. 10 are interconnected via a system bus 602. Additional subsystems include a printer 604, a keyboard 606, a fixed disk 608, and a monitor 610, which is coupled to a display adapter 612. Peripherals and input/output (I/O) devices, which couple to an I/O controller 614, can be connected to the computer system by any number of means known in the art, such as a serial port 616. For example, the serial port 616 or an external interface 618 can be utilized to connect the computer device 600 to further devices and/or systems not shown in FIG. 10 including a wide area network such as the Internet, a mouse input device, and/or a scanner. The interconnection via the system bus 602 allows one or more processors 620 to communicate with each subsystem and to control the execution of instructions that may be stored in a system memory 622 and/or the fixed disk 608, as well as the exchange of information between subsystems. The system memory 622 and/or the fixed disk 608 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, Javascript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A system for automatically generating documents with customer preferred terminology, the system comprising at least one server configured to:
provide at least one basic terminology document for a system;
store customer specific terminology for a first customer;
receive a request for the basic terminology document for the first customer;
search the basic terminology document for at least one tag placeholder corresponding to a redefined term in the customer specific terminology for the first customer;
preprocess the basic terminology document to replace the tag placeholder with the redefined term in order to create a customer specific terminology document for the first customer; and
provide the customer specific terminology document for the first customer for display.

2. The system for automatically generating documents with customer preferred terminology of claim 1, where the server is further configured to:
store customer specific terminology for a second customer, where the customer specific terminology for the first tenant is different than the customer specific terminology for the second customer;
receive a request for the basic terminology document for the second customer;
search the basic terminology document for at least one tag placeholder corresponding to a redefined term in the customer preferred terminology for the second customer;
preprocess the basic terminology document to replace the tag placeholder with the redefined term for the second customer in order to create a customer specific terminology document for the second customer; and
provide the customer specific terminology document for the second customer for display.

3. The system for automatically generating documents with customer preferred terminology of claim 2, where the system further comprises a multi-tenant system and where the first and second customers are different tenants of the multi-tenant system.

4. The system for automatically generating documents with customer preferred terminology of claim 1, where the server is further configured to:
receive a search request for basic terminology documents for the first customer;
search the search request for one or more redefined terms in the customer specific terminology for the first customer;
replace each redefined term in the search request with a corresponding tag placeholder corresponding to the redefined term in the search request; and
search the basic terminology documents using the corresponding tag placeholders for the redefined terms in the search request.

5. The system for automatically generating documents with customer preferred terminology of claim 1, where the system is further configured to:
detect at least one capitalized character in the tag placeholder; and
capitalize a character in the redefined term that corresponds to the capitalized character in the tag placeholder.

6. The system for automatically generating documents with customer preferred terminology of claim 1, where the server is further configured to:
detect a plural character in the tag placeholder; and
provide a plural form of the redefined term.
detect a plural character in the tag placeholder; and
provide a plural form of the redefined term.

7. The method for automatically generating documents with customer preferred terminology of claim 1, where the server is further configured to:
detect an indefinite article preceding the tag placeholder; and
replace the indefinite article preceding the tag placeholder with an indefinite article that is appropriate for the redefined term.

8. A method for automatically generating documents with customer preferred terminology, the method comprising:
providing at least one basic terminology document for a system;
storing customer specific terminology for a first customer;
receiving a request for the basic terminology document for the first customer;
searching the basic terminology document for at least one tag placeholder corresponding to a redefined term in the customer specific terminology for the first customer;
preprocessing the basic terminology document to replace the tag placeholder with the redefined term in order to create a customer specific terminology document for the first customer; and
providing the customer specific terminology document for the first customer for display.

9. The method for automatically generating documents with customer preferred terminology of claim 8, the method further comprising:
storing customer specific terminology for a second customer, where the customer specific terminology for the first tenant is different than the customer specific terminology for the second customer;
receiving a request for the basic terminology document for the second customer;
searching the basic terminology document for at least one tag placeholder corresponding to a redefined term in the customer preferred terminology for the second customer;
preprocessing the basic terminology document to replace the tag placeholder with the redefined term for the second customer in order to create a customer specific terminology document for the second customer; and
providing the customer specific terminology document for the second customer for display.

10. The method for automatically generating documents with customer preferred terminology of claim 9, where the system further comprises a multi-tenant system and where the first and second customers are different tenants of the multi-tenant system.

11. The method for automatically generating documents with customer preferred terminology of claim 8, the method further comprising:
receiving a search request for basic terminology documents for the first customer;
searching the search request for one or more redefined terms in the customer specific terminology for the first customer;
replacing each redefined term in the search request with a corresponding tag placeholder corresponding to the redefined term in the search request; and
searching the basic terminology documents using the corresponding tag placeholders for the redefined terms in the search request.

12. The method for automatically generating documents with customer preferred terminology of claim 8, the method further comprising:
detecting at least one capitalized character in the tag placeholder; and
the step of preprocessing the basic terminology document to replace the tag placeholder with the redefined term in order to create a customer specific terminology document for the first customer further includes capitalizing a character in the redefined term that corresponds to the capitalized character in the tag placeholder.

13. The method for automatically generating documents with customer preferred terminology of claim 8, the method further comprising:
detecting a plural character in the tag placeholder; and
the step of preprocessing the basic terminology document to replace the tag placeholder with the redefined term in order to create a customer specific terminology document for the first customer further includes providing a plural form of the redefined term.

14. The method for automatically generating documents with customer preferred terminology of claim 8, the method further comprising:
detecting an indefinite article preceding the tag placeholder; and
the step of preprocessing the basic terminology document to replace the tag placeholder with the redefined term in order to create a customer specific terminology document for the first customer further includes replacing the indefinite article preceding the tag placeholder with an indefinite article that is appropriate for the redefined term.

15. A computer readable medium having computer-executable instructions stored thereon which, when executed by a computer, will cause the computer to perform a process for automatically generating documents with customer preferred terminology, the process comprising:
providing at least one basic terminology document for a system;
storing customer specific terminology for a first customer;
receiving a request for the basic terminology document for the first customer;
searching the basic terminology document for at least one tag placeholder corresponding to a redefined term in the customer specific terminology for the first customer;
preprocessing the basic terminology document to replace the tag placeholder with the redefined term in order to create a customer specific terminology document for the first customer; and
providing the customer specific terminology document for the first customer for display.

16. The computer readable medium of claim 15, the process further comprising:
storing customer specific terminology for a second customer, where the customer specific terminology for the first tenant is different than the customer specific terminology for the second customer;
receiving a request for the basic terminology document for the second customer;
searching the basic terminology document for at least one tag placeholder corresponding to a redefined term in the customer preferred terminology for the second customer;
preprocessing the basic terminology document to replace the tag placeholder with the redefined term for the second customer in order to create a customer specific terminology document for the second customer; and
providing the customer specific terminology document for the second customer for display.

17. The computer readable medium of claim 16, where the system further comprises a multi-tenant system and where the first and second customers are different tenants of the multi-tenant system.

18. The computer readable medium of claim 15, the process further comprising:
receiving a search request for basic terminology documents for the first customer;
searching the search request for one or more redefined terms in the customer specific terminology for the first customer;
replacing each redefined term in the search request with a corresponding tag placeholder corresponding to the redefined term in the search request; and
searching the basic terminology documents using the corresponding tag placeholders for the redefined terms in the search request.

19. The computer readable medium of claim 15, wherein the process further includes;
detecting at least one capitalized character in the tag placeholder; and
the step of preprocessing the basic terminology document to replace the tag placeholder with the redefined term in order to create a customer specific terminology document for the first customer further includes capitalizing a character in the redefined term that corresponds to the capitalized character in the tag placeholder.

20. The method for automatically generating documents with customer preferred terminology of claim 15, wherein the process further includes:
detecting a plural character in the tag placeholder; and
the step of preprocessing the basic terminology document to replace the tag placeholder with the redefined term in order to create a customer specific terminology document for the first customer further includes providing a plural form of the redefined term.

21. The computer readable medium of claim 15, wherein the process further includes:
detecting an indefinite article preceding the tag placeholder; and
the step of preprocessing the basic terminology document to replace the tag placeholder with the redefined term in order to create a customer specific terminology document for the first customer further includes replacing the indefinite article preceding the tag placeholder with an indefinite article that is appropriate for the redefined term.
